(19) United States
(12) Patent Application Publication
(10) Pub. No.: US 2009/0157664 A1
(43) Pub. Date: Jun. 18, 2009

(54) SYSTEM FOR EXTRACTING ITINERARIES FROM PLAIN TEXT DOCUMENTS AND ITS APPLICATION IN ONLINE TRIP PLANNING

(76) Inventor: CHIH PO WEN, Redwood City, CA (US)

Correspondence Address: CHIH PO WEN, 529 OSPREY DRIVE, REDWOOD CITY, CA, 94065, US

(21) Appl. No.: 12/328,768

(22) Filed: Dec. 5, 2008

Related U.S. Application Data
(60) Provisional application No. 61/007,426, filed on Dec. 13, 2007.

(51) Int. Cl. G06F 7/06; G06F 17/30

(52) U.S. Cl. 707/5; 707/3; 707/E17.108

(57) ABSTRACT

The present invention is a system that extracts itineraries from plain text documents and uses them to plan new trips. The extracted data is stored in an itinerary database and a user can retrieve the itineraries using a plurality of search criteria on the trip content. The system also uses the data in the stored itineraries to recommend destinations, trip outlines and trips that are relevant to the user.

### CROSS REFERENCE TO RELATED APPLICATIONS

This application claims the benefit of provisional patent application U.S. U.S. 61/007,426, filed Dec. 13, 2007 by the present inventor. The contents of U.S. 61/007,426 are expressly incorporated herein by reference thereto.

### FIELD OF INVENTION

The present invention is in the technical field of Computer and Information Sciences. More particularly, it is in the technical field of the processing, storage, and retrieval of travel-related documents for the purpose of online trip planning. Specifically, the invention addresses the plain text documents that describe trip itineraries and the system for utilizing these documents to plan new trips.

### BACKGROUND OF INVENTION

The description of the present invention uses the terms trip plan, trip itinerary and trip agenda interchangeably to describe the writing about a past or a future trip that contains a detailed, day-by-day schedule of destinations to visit. We use the term destination loosely to refer to a location (e.g., city), an attraction, an event (e.g., a Broadway show), an activity (e.g., a museum trip), a hotel or a restaurant.

In recent years we have been seeing a steady growth of travelers that plan their trips using online tools. A substantial number of such travelers also publish their trip itineraries on the Internet in the form of community blogs, personal web pages or pages on a hosting travel site. In addition to the travelers, there are also an increasing number of travel-related merchants (such as tour operators, resellers or travel agents) promoting their products online.

Despite its abundance, the vast majority of the online trip content is stored as plain text documents without any structure that is immediately accessible to sophisticated trip planning applications. For example, a user cannot effectively search a large collection of plain-text documents to find the itineraries that contains a specific length of stay in one or more locations. Neither can the user obtain high quality recommendations from an automated system, such as the places to visit or the length of stay in a location given one or more restrictions or preferences. Therefore, planning a trip online is currently a slow and labor-intensive process. The user would use one or more generic search engines (such as those offered by Yahoo or Google) to find documents containing a number of keywords. The search results are usually very noisy—they often produce itineraries that are irrelevant, or worse yet, documents that are simply not travel related. Therefore, the user must skim the results one by one to find the useful documents.

A number of existing web sites allow the users to construct a trip diary using an interactive user interface. Such an interface typically requires the users to go through a series of steps to search and add a place in the itinerary. This skilled approach requires a lot of work from the user to construct an itinerary. Furthermore, it does not address the vast collection of plain text itinerary documents that already exist on the Internet. Therefore, such sites fail short of providing the user with help for planning new trips.

Part of the trip planning process often includes reusing bits and pieces of one or more itineraries to create one's own customized trip. For example, a traveler who plans to spend two week in Italy and France may wish to look at some itineraries for Italy and some other itineraries for France. Again, looking for relevant trips is a labor-intensive if one is restricted to using a generic search engine that matches keywords in plain text documents.

The last part of the trip planning process is to book the trip. For trips that span multiple destinations, the user must find, choose and perhaps combine the products offered by one or more merchants, Currently, the merchants offer very limited search capabilities, most of which are based on the plain text description of their products and at best, the ability to return a list of products that are linked to a single destination. Therefore, it is difficult for a traveler to find relevant products, and for a merchant to find interested traveler that may benefit from its products.

The present invention aims to address the shortcomings of the other trip planning systems using a novel system that utilizes existing plain text itineraries.

### BRIEF SUMMARY OF INVENTION

The present invention is a system that extracts itineraries from plain text documents and uses them to plan new trips. The extracted data comprise the detailed schedule for the underlying trip's points of interests (e.g., countries, regions, cities, neighborhoods and attractions), activities (e.g., events, shows), places to stay (e.g., hotels) and transportation.

The same system stores the extracted data in an itinerary database so that they can be used to plan new trips. The itinerary database comes with a novel itinerary search engine that not only supports keyword-based search but also supports sophisticated searches by multiple constraints, including but not limited to the destinations and their length of stay, the time of travel and the cost of the trip (for commercial tours).

The same system also contains a recommendation engine that provides the user with relevant recommendations, including but not limited to high-level trip schedules, example itineraries, destinations to visit, things to do and products to buy.

The services of the system is delivered via an interactive user interface that allows the user to search, view, create or modify detailed itineraries and to receive recommendations from the system.

### BRIEF DESCRIPTION OF THE DRAWINGS

FIG. 1 is the high-level diagram showing the top-level components of the trip planning system according to the teachings of the invention.

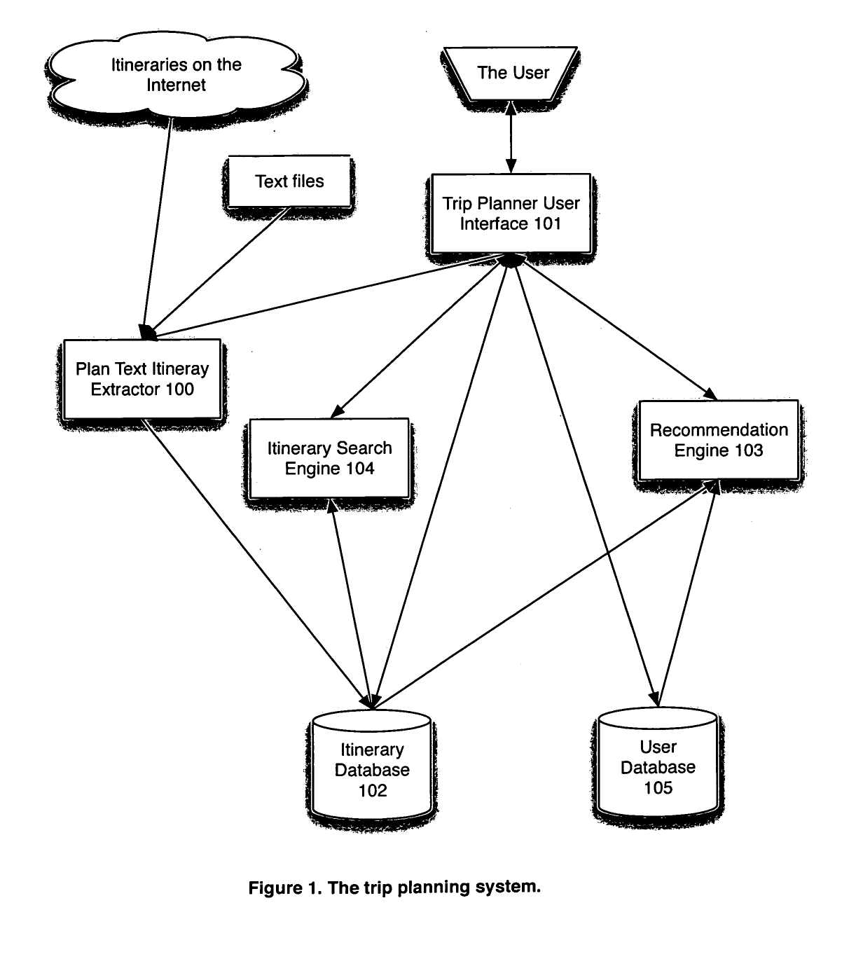

FIG. 2 depicts a preferred embodiment of the plain text itinerary extractor according to the teaching of the invention.

FIG. 3 shows an example plain text itinerary document.

FIG. 4 shows two example records in the point of interest database.

FIG. 5 shows an example scenario for resolving the ambiguity of place name references in an itinerary document.

FIG. 6 shows an example record in the itinerary database, drawing from the example in FIG. 3.

FIG. 7 shows a number of example recommendations.

FIG. 8 shows the preferred embodiment of the trip planner user interface according to the teachings of the invention.

### DETAILED DESCRIPTION OF THE INVENTION

System Overview

Referring now to the invention in more detail, FIG. F1 shows the high-level diagram of a system employing the teachings of the invention. The plain text itinerary extractor 100 retrieves the text documents from the web, processes the documents to turn them into detailed itineraries and then saves the result in the itinerary database 102. Alternatively, a user may also supply the plain text document to the plain text itinerary extractor 100 via the trip planner user interface 101.

In the preferred embodiment, the plain text itinerary extractor keeps a list of known travel web sites and uses a web crawler (prior art) to periodically scan the sites for web pages that contain itineraries. In a different embodiment, a human agent supplies the extractor with a list of URLs that point to the web pages that contain itineraries. In another embodiment, a human agent simply supplies a list of files that contain the plain text documents themselves.

The itinerary database 102 stores all extracted itineraries and makes the data available for use by the itinerary search engine 104, the recommendation engine 103 and the trip planner user interface 101. The plain text itinerary extractor 100 periodically refreshes the content of the itinerary database to pick up the latest data such as the price and the date of availability for commercial trips.

The itinerary search engine 104 allows the user to issue a variety of search queries (via the trip planner interface 101) against the data in the itinerary database 102. The search engine parses the user queries, retrieves the results and then paginates or sorts them based on the user's specification.

The recommendation engine 103 computes the most relevant recommendations and provides them to the user via the trip planner user interface 101. The user database 105 stores all data relevant to the user based on the past interaction of the system with the user. The system ranks the recommendations by their estimated relevance to the end user, considering the user's current task as well as the user's profile and behavioral data.

The trip planner user interface 101 exposes the system's capabilities to the end user, who can be an active traveler ready to plan or book a pending trip, or a passive user who is interested getting ideas for a possible future trip.

The Plain Text Itinerary Extractor

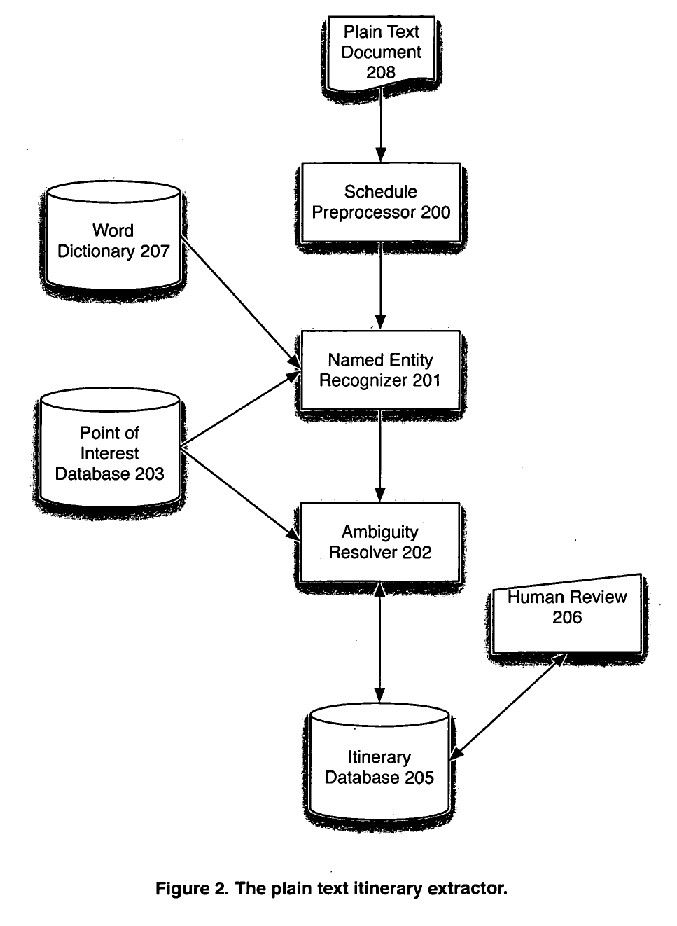

FIG. 2 depicts the preferred embodiment of the plain text itinerary extraction process according to the teachings of this invention.

The process starts with an input plain text document 208, which can be a HTML document originating from a travel-related web site, a simple text document typed up by a user, or a database export from a travel vendor's database. The schedule preprocessor 200 identifies the portion of the text that corresponds to a travel itinerary, removes the “chrome” (e.g., the HTML tags) from the text portion and then breaks up the text by the dates of travel.

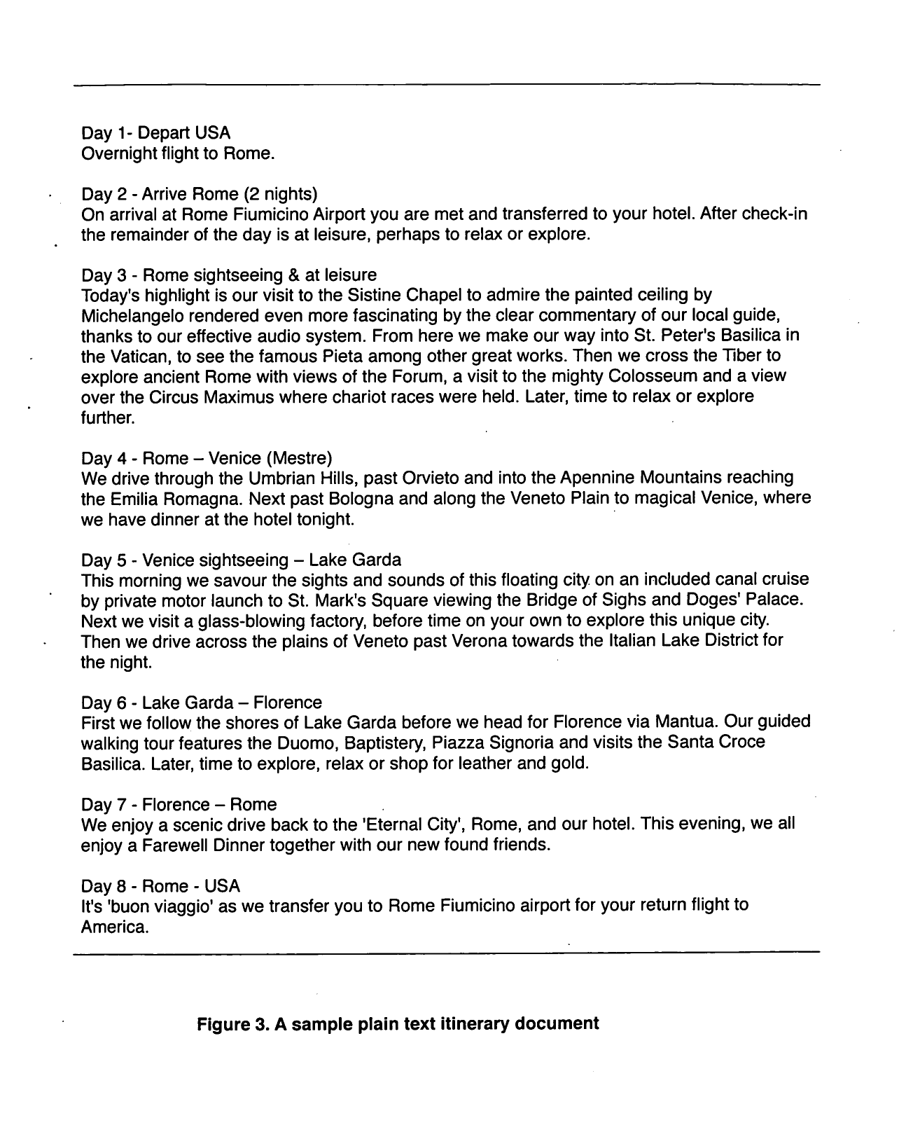

In the preferred embodiment, a schedule preprocessor 200 uses a data-source independent algorithm to process stylized documents where there are distinctive text “markers” that demarcate the trip schedule. We found that almost all of the commercial tour packages on the web follow more or less the same format. FIG. 3 shows an example plain text itinerary document that describes a commercial tour package for a trip to Italy. From this example, we can see that the schedule can be easily determined by the date or “day” words (e.g., Day 1). The algorithm is described in details below:
1. Find all character sequences in the document that match one or more pre-determined character patterns. In the preferred embodiment, we express such patterns using the regular expression syntax, which is a well-known computer language construct supported by many programming languages such as Java and Perl. Examples of such patterns include but are not limited to “Day [0-9]+”, which matches a date number like “Day 1”, or “[0-9]+/[0-9]+/[0-9]+”, which matches a date like “11/01/2007”.
2. If the input document is HTML, parse the document into a DOM (Document Object Model) tree and find the least common DOM parent of the HTML elements containing the matched character sequences. In most cases, the document portion under the parent contains the entire itinerary and the rest of the document is considered “chrome” and can be discarded.
3. Separate the document or document portion into multiple sections, each of which starts with a character sequence that matches the above date patterns.
4. Parse the dates or days number from the matched character sequences and attach them to the sections that they demarcate. We now have the high-level schedule of the trip, although the schedule still lacks the detailed content (other than the raw text).

In another embodiment of the schedule preprocessor 200, the format of the document is specific to the data source. In this case, a different text extractor algorithm can be implemented for each data source. A person skilled in the art of HTML and generic programming can easily write implement an algorithm for a well-specified data source. Such a custom-made algorithm may also be able to extract additional information about the trip, such as the trip title, trip cost (for commercial tour packages) and the countries visited in the trip.

The high-level schedule produced by the schedule preprocessor 200 is sent to a named entity recognizer 201, where phrases such as “Rome” or “Pantheon” are converted to a list of destination references. In the preferred embodiment, the name entity recognizer 201 uses a set of simple and fast syntactic rules to identify phrases that may refer to a location. The rules comprises the following:
Shape rule #1: if the phrase starts with a capitalized letter, it may refer to a location.
Shape rule #2: if the phrase is followed by a capitalized word, it may not refer to a location (rather, it may be the prefix of a longer phrase that refers to a location).
Stop word rule: if the phrase corresponds to a “stop word” (e.g., articles such as “a”, “an”, “the”, “this”, “that”), it cannot refer to a location.

In another embodiment, the name entity recognizer 201 may incorporate existing techniques in Natural Language Processing (NLP) to tag the nouns in the document. Such a tool is usually called the Part-of-Speech (POS) tagger. The non-noun words are then removed from consideration.

After identifying the relevant phrases in the document, the name entity recognizer 201 then matches the phrases against the records in the point of interest database 203 to “bind” each the phrases to their destinations. The phrase match is purely text-based and it may result in multiple possibilities for an ambiguous phrase. For example, the phrase “Rome” would match several records in the point of interest database 203, such as Rome, Italy and Rome, Georgia, USA.

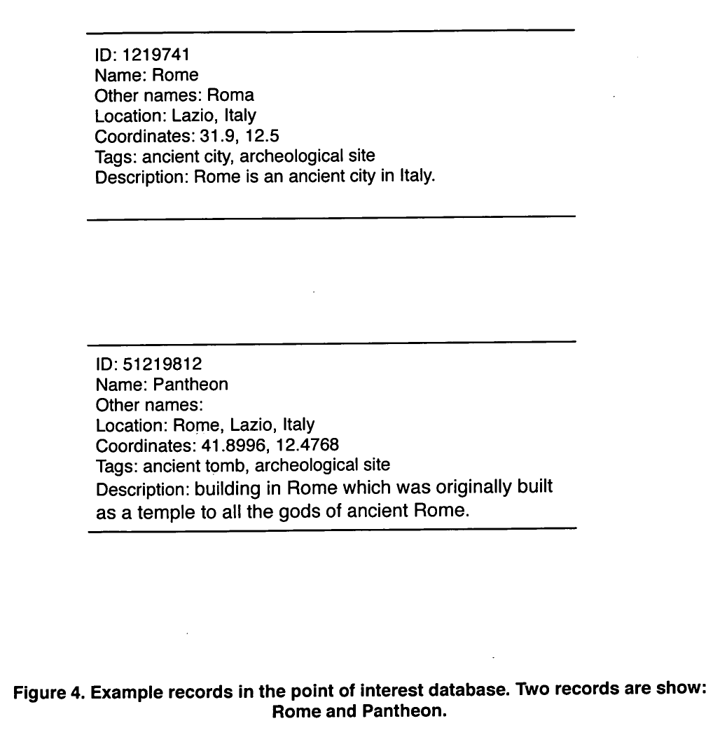

The point of interest database 203 contains the records for all known point of interests, including but are not limited to countries, regions/states, cities, towns, neighborhoods, attractions, places to stay . . . etc. Each record has several descriptive attributes, including but are not limited to the name, aliases (i.e., other known names), location, coordinates, tags or categories and description. FIG. 4 shows a couple examples records in the database. The records can be constructed programmatically from a number of data sources on the web (e.g., Wikipedia and geonames.org) or purchased from a variety of vendors.

The results of the named entity recognizer 201 are sent to an ambiguity resolver 202, where multiple destinations of the same (ambiguous) phrase are resolved into a single destination. For example, the references to “Rome” in the sample itinerary in FIG. 3 should be resolved to Rome Italy, not Rome, Georgia, USA. The ambiguity resolver 202 may use one or more rules to determine which destination should be chosen for a particular phrase. In the preferred embodiment, the rule is to minimize the total distance traveled. The rule is effective because it is consistent with how we plan our trips—we minimize the time spent on transportation and maximize the time spent in enjoying the destinations. However, for longer trips the destinations may shift from one country to another. Therefore, we will apply the distance rule “locally” one date at a time.

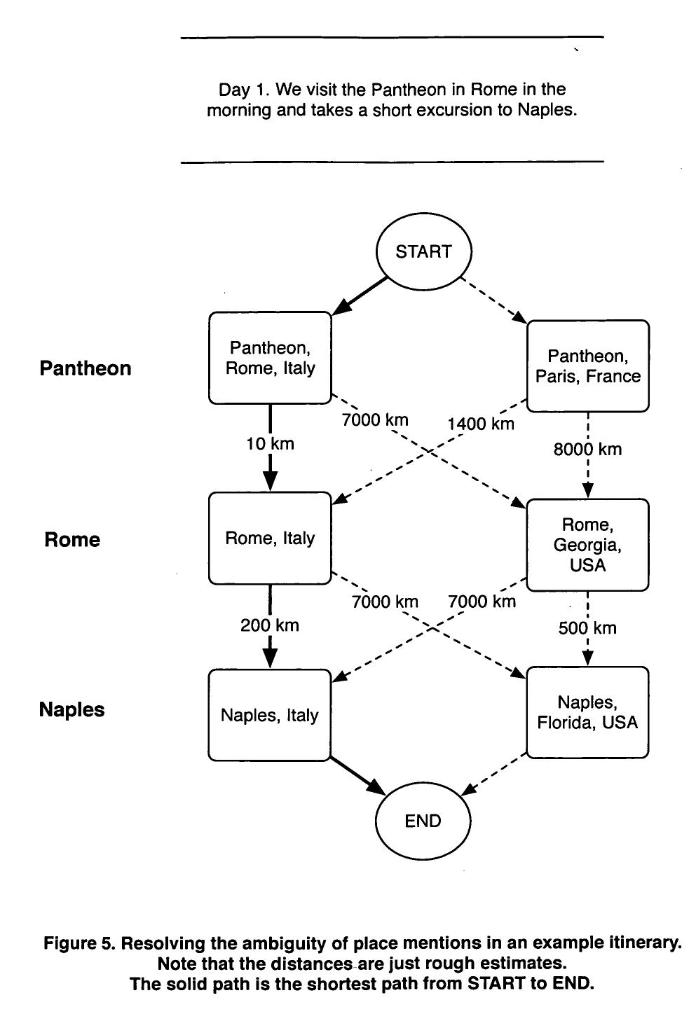

The problem for calculating the minimize distance can be mapped to the “shortest path” problem, which has known algorithmic solutions. To formulate the shortest path problem, we create a network (an acyclic graph with a start node and an end node) where each level represents a phrase and the nodes for the level represent the destinations matching the phrase. Two nodes in consecutive levels are connected via edges that are annotated with the distance between their destinations. To finish off the graph, we add a start node and connect it to the first matched phrase in the itinerary (with zero distance). Similarly, we also add an end node and connect it to the last matched phrase (with zero distance). The shortest path from the start node to the end node tells us which destination to use for which phrase. FIG. 5 contains an example that illustrates the working of the algorithm.

Referring now to the method of calculating the distance of travel, in one embodiment, the distance between two locations is calculated as the straight-line distance between the coordinates of the locations (as specified in the point of interest database 203). In an alternative embodiment, the distance calculation uses a routing algorithm, such as that used in a GPS navigation device for computing the driving distance between the locations. The former is faster and more generally applicable, while the latter is more accurate in certain cases.

The ambiguity resolver 202 also employs a set of rules to check the resulting itinerary to make sure it is sensible. In the preferred embodiment, the rule checks the total distance traveled in a single day and make sure it does not exceed a specified limit, except when the date contains long-distance transportation (e.g., when flying from one country to another). In the preferred embodiment, such exceptions are detected by matching the words used in the itinerary text against a small dictionary of “indicator words”, including but not limiting to words such as “flight”, “cruise”, “fly” . . . etc. When the ambiguity resolver 202 determines that the resulting itinerary is not sensible, possibly due to the incorrect inclusion of a phrase that does not refer to a location in the trip, it selects and removes the phrase from the itinerary and re-processes the document. In the preferred embodiment, the phrase whose removal shortens the total distance the most is removed. In a different embodiment, the selection of the phrase is based on the feedback from the user. In another embodiment, the selection of the phrase is based on the statistical estimation of the likelihood of inclusion. Such statistics can be computed from other processed documents in the itinerary database.

The algorithm used by the ambiguity resolver 202 is described below:
R1. If the itinerary document specifies the countries of visit, check the point of interest database 203 and eliminate the candidate destinations that are not in the specified countries.
R2. Repeat the following steps for each date in the trip schedule:
   R2.A Repeat the following steps until a valid result is found:
      Include the phrases for the current date as well as its previous and next date, if applicable. The phrases from the previous and the next dates provide additional contextual data to the algorithm and thus increase the likelihood of finding a good solution.
      Create the network of nodes based on the set of phrases, as described above.
      Compute the shortest path from the start node to the end node.
      If the shortest distance exceeds a specified limit AND the included date does not involve long-distance transportation:
         Compute the phrase whose removal leads to the most reduction in the shortest distance.
         Remove the phrase from the set for consideration.
         Go back to the top of step R2.A.
      Otherwise, we have found a solution. Complete step R2.A and move on to the next date in the trip schedule in step R2.

The Itinerary Database and the Itinerary Search Engine

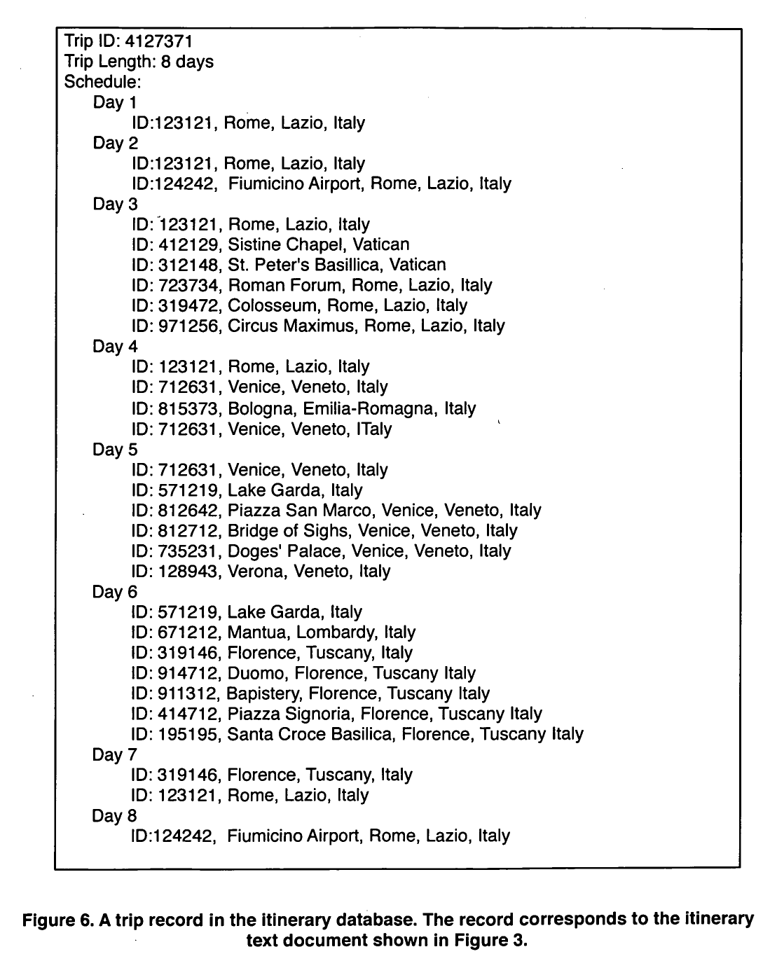

The results of the plain text itinerary extractor 100 are stored in the itinerary database 102. Each result describes the high-level schedule of the trip (e.g., what city on what date) as well as the detailed schedule for each date (e.g., the list of attractions and things to do). FIG. 6 shows the itinerary database 102 record for the itinerary document in FIG. 3.

The records in the itinerary database 102 are indexed in many different ways so that the itinerary search engine 104 can process the user queries efficiently. In the preferred embodiment, the indices include but are not limited to:
The costs for the trips that are offered as a tour package by a merchant.
The lengths for the trips.
The list of destinations for a trip.
The list of trips containing a destination.
The list of trip dates (i.e., trip+day number) containing a destination.
The list of cities, regions and countries for a trip.
The trips for each city, region and country.

In the preferred embodiment, the itinerary data and indices reside in the main memory of a computer that computes the search. In another embodiment, the indices are stored in a relational database with indexing capabilities, such as those products offered by Oracle, IBM and Microsoft.

The itinerary search engine 104 processes a variety of novel queries that are not found in existing trip planning or booking systems. The questions include but are not limited to the following:
Q1: What trips include one or multiple given destinations?
Q2: What trips include a stay at a given location for at least (or at most) a certain number of days?
Q3: What trips exclude a given destination?
Q4: What trips are longer than (or shorter than) a certain number of days?
Q5: What trips start (or finish) in a given location?
Q6: What trips include at least a visit to a point of interest in a certain category (e.g., museum)?
Q7: what trips cost more or less than a given amount?
Q8: what trips contain destinations in the “archeological site” category?

The above questions can be further combined to create a more complex question, using the conjunction operator (“and”), the disjuction operator (“or”) and the negation operator (“not”).

The following is an example of a complex query:
QC: What 7-day trip includes at least 2 days in Rome, Venice and Florence but not Milan, and cost $2000 or less?

In the preferred embodiment, the itinerary search engine 104 uses a query language that is a subset of the English language. The query language may be based on several well-known search phrases that can be combined using logical operators such as “and”, “or” and “not”. The phrase syntax comprises the following:
P1: <name>
P2: <n> days in <name>
P3: at most <n> days in <name>
P4: at least <n> days in <name>
P5: at most <n> days in <name>
P6: <n> days
P7: at most <n> days
P8: at least <n> days
P9: starting with <name>
P10: ending with <name>
P11: at least $<n>
P12: at most $<n>
Where <n> is a number specifying the date in the itinerary (e.g., day 3), and <name> is either the name of a location such as “Europe”, the name of a point of interest such as “The Louvre Museum in Paris” or the name of a category such as “archeological site”. When <name> is omitted from the search phrase, the constraint applies to the entire itinerary. For example, the search phrase “at least 10 days” means the length of the entire trip is at least 10 days.

The query string for the question QC looks like:
“7 days and at least 2 days in Rome and Venice and Florence and not Milan and at most $2000”

The User Database

The user database 105 stores everything the system knows about the user. In the preferred embodiment, the user database contains the following information:
Trips: the list of the trips created by the user. Note that the actual trip content (e.g., the detailed schedule of activities) is stored in the itinerary database 102.
Recently viewed destinations (e.g., the past 2 weeks)
Recently viewed trips (e.g., over the past 2 weeks)
Bookings (e.g., hotel and flight reservations).
The user's profile data, such as the following:
   The user's last logged on IP address (for inferring the user's physical location).
   The user's demographic attributes, such as gender, home address, age and income band.
   The user's declared travel interests (e.g., “Art”, “Outdoors”, “Child-friendly” . . . etc).

In the preferred embodiment, the user database resides in the main memory of the computer providing the services. In an alternative embodiment, the user database is stored in a relational database with indexing capabilities.

The Recommendation Engine

The recommendation engine 103 actively makes recommendations as the user interacts with the system through the trip planner user interface 101. The recommendation engine makes the following type of recommendations:
Trip outline: the high-level schedule of a trip, including the visited cities and their dates of visit. For example, a 5-day schedule starting with 3 days in Rome, Italy and then 2 days in Venice.
Itinerary: an itinerary in the itinerary database 102.
Destination: a destination such as a city or an attraction.

The recommendation engine 103 ranks the recommendations based on their estimated relevance to the end user. Relevance is determined based on a collection of input variables (called the recommendation context), which include but are not limited to the following:
The trip that is being modified by the user in the trip planner user interface 101, if any. We shall refer to this trip as the “current trip”.
The trip or destination that is being viewed by the user in the trip planner user interface 101.
The trips created by the user, if any, as stored in the user database 105.
The trips and destinations recently viewed by the user, as stored in the user database 105.
The user's profile from the user database 105.

To compute the list of recommendations, the recommendation engine 103 combines the list of input variables and compares the result against the destinations or trips in the itinerary database 102. A relevance score is computed for each candidate recommendation, and the recommendation engine 103 returns the top results based on their relevance score.

In the preferred embodiment, each destination is represented as a feature vector, which is a mapping from a feature name (also called a feature for brevity) to a feature value. The feature value is normally an integer count representing the number of occurrences of the feature name for the destination in consideration. For example, given the destination “Paris, France” and the feature name “visited in January”, the feature value is the number of trips that visited Paris in January. In the preferred embodiment, the count is further divided by the total number of occurrences for the feature name over all destinations. For the “visited in January” example, the count is divided by the total number of trips that visited some destination in January. The normalization enables the system to give higher weights to rare events when comparing destinations and trips.

The feature vectors for multiple destinations can be merged into a single feature vector by combining the feature values for the same feature name. In the preferred embodiment, the combination uses the sum of the feature values. In a different embodiment, the combination uses the max of the feature values. Consequently, we can think of a trip as a collection of visited destinations, and its feature vector is simply the merged feature vector of these destinations, plus several trip-specific features such as the trip length. In fact, the entire recommendation context can be combined into a single feature vector for comparison against the itinerary database 102.

In the preferred embodiment, the features comprise the following:
F1: the length of the trip, if applicable.
F2: the categories for the trip or the destination. Each category is essentially a separate feature so that we can represent multiple applicable categories.
F3: the ID of the destination, or the IDs of all destinations visited in the trip.
F4: the IDs of all trips containing the destination, if applicable.
F5: the month(s) of travel for the trip, or for all trips containing the destinations.
F6: the trip dates (i.e., trip ID+day number) containing the destination, if applicable.
F7: the IDs of all destinations that are visited in the same trip as the given destination.
F8: the IDs of all destinations that are visited in the same trip and on the same day as the given destination.
F9: the cost band (e.g., $0-$1000, $1000-$2000, $2000 and above) for the trip, or for all trips containing the destinations.
F10: the user profile attributes of all users who visited the destination, such as the demographic attributes and the declared travel interests.

The relevance score between two feature vectors are computed as the weighted, normalized dot product of the two vectors, which is similar to the “cosine similarity” in the field of text information retrieval. The scores are normalized to the range from zero and one, the higher the more relevant. The scores are usually presented in the user interface as a percentage, such as 60% for the score of 0.60.

The feature weights allow us to control what features matter the most. For example, the weight for F8 is higher than the F7, because F8 is deemed to more specific. In the typical embodiment, the weights are pre-determined by rules. In an alternative embodiment, the system uses a machine learning method to fit the weights against the data in the itinerary database. For example, we can use a simple least square error procedure to fit the weights, where the error is the number of false negatives or false positives on the recommended destination or trip in relation to a currently viewed destination or trip. A person skilled in the art of basic statistical regression or machine learning will appreciate various modifications of the embodiment described above which fall within the teachings of the invention.

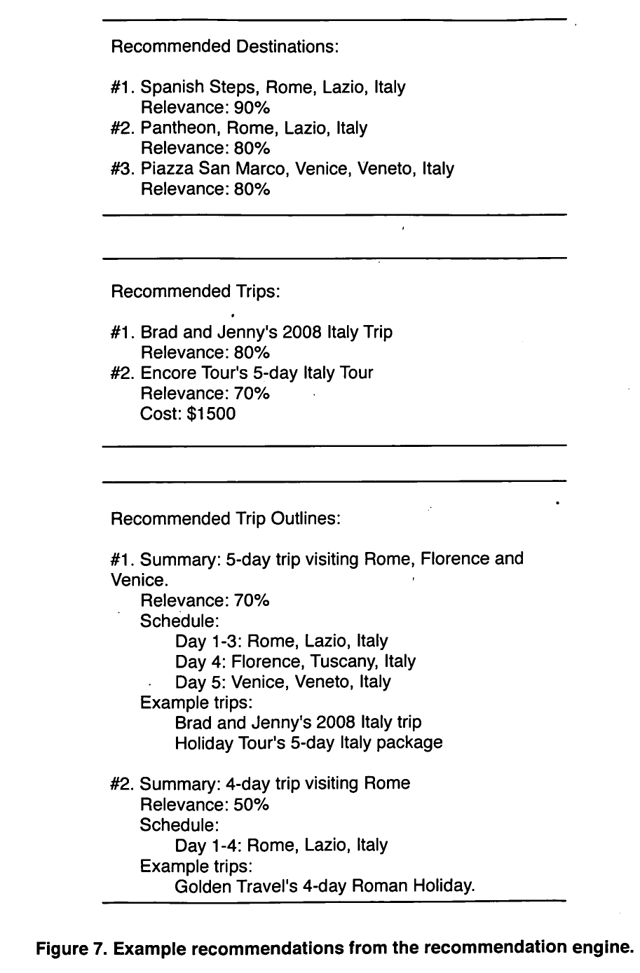

Referring now to the specific types of recommendations made by the system, FIG. 7 shows two examples for each type of recommendation. The recommendations are shown in the trip planner user interface 101 alongside the user's work area. The recommendations are usually listed in descending order of their relevance scores, but the user interface may present the user with options to sort the results differently, for example, by name or by cost.

The content of a recommended destination includes but is not limited to the name and location of the destination and its relevance score. In the preferred embodiment, the recommendation engine 103 considers only the subset of all destinations in the itinerary database 102 where the destination overlaps with the recommendation context. For example, if the recommendation context consists of a trip visiting Rome and Venice, only those destinations that are visited in the same trip as either Rome or Venice will be considered. The relevance score is computed for each destination in the subset and the top few destinations are chosen for recommendation.

The content of a recommended trip includes but is not limited to the trip title (or a machine generated short summary if the title is not given), the relevance score and the cost of the trip (when applicable). In the preferred embodiment, the recommendation engine 103 considers only the subset of all trips in the itinerary database 102 where each trip has at least one overlapping destination with the recommendation context. For example, if the recommendation context consists of a trip visiting Rome and Venice, only those trips that contain either Rome or Venice will be considered. The relevance score is computed for each trip in the subset and the top few trips are chosen for recommendation.

The content of a recommended trip outline includes but is not limited to the short summary, the computed relevance score, the high-level schedule with the dates and locations (but not the detailed list of activities), and one or more example trips that matches the outline. In the preferred embodiment, the recommended trip outlines are simply computed from the top recommended trips. The relevance score of the trip outline can be taken as the maximum relevance score of all recommended trips matching the outline. The example trips are simply the subset of the recommended trips that have the highest relevance scores.

The Trip Planner User Interface

The user uses the trip planner user interface 101 to communicate with all system services. The interface allows the user to accomplish the following tasks:
Search and view destinations and itineraries (via the itinerary search engine 104).
Receive recommendations from the system (via the recommendation engine 103).
Register with the system and provide profile data in the user database 105.
Create trips from scratch and save them to the itinerary database 102.
Recall created trips from the itinerary database 102 and make modifications.

In the preferred embodiment, the user interface is web-based. That is, it runs in the web browser and connects to the rest of the system via HTTP or secure HTTP.

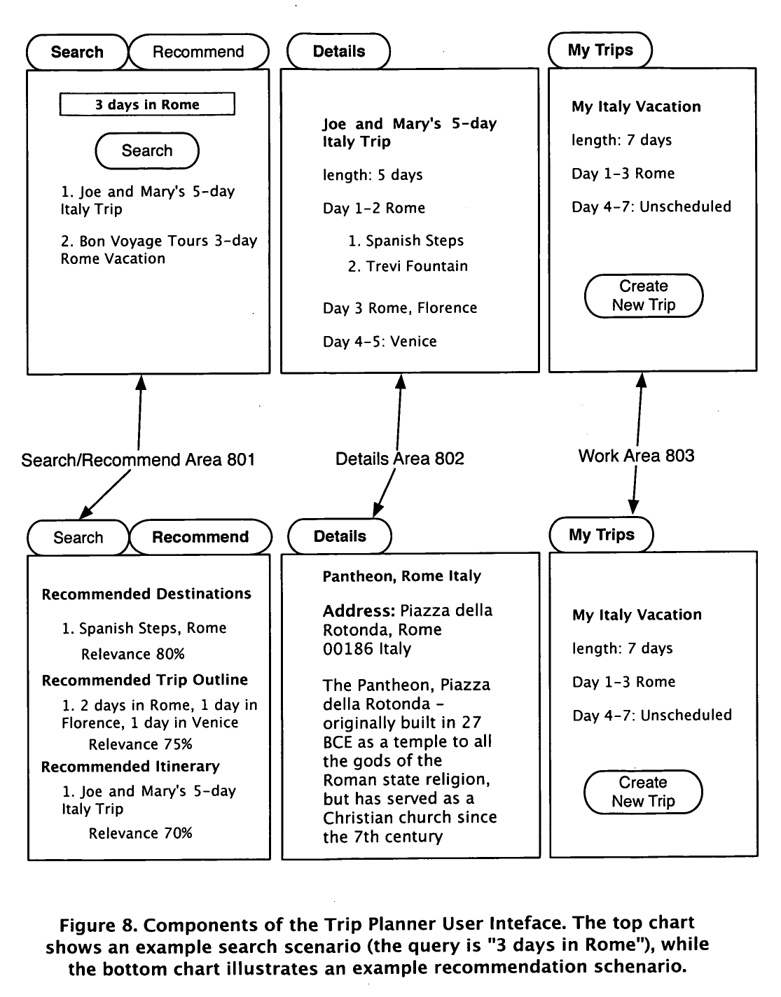

In the preferred embodiment, the user interface resembles those shown in FIG. 8. The user interface consists of the following main components:
A search/recommend area 801 for showing the results of a user query, and the list of recommendations made by the system (on the left hand side in FIG. 8).
A details area 802 for showing the detailed information of a destination or trip (in the middle of FIG. 8).
A work area 803 for showing the trip that the user is currently working on ((on the right hand side in FIG. 8).

The search/recommend area 801 operates in two modes: search and recommendation. The user may switch the mode manually using a UI control element, such as the two tabs shown in FIG. 8. In the search mode, the user types in a query (e.g., for the itinerary search engine 104). The user interface sends the query to the system for processing, and the system returns a list of results (e.g., trip names) matching the queries. The results can be sorted in a number of ways, such as by name, by the system assigned relevance or by cost (if the results are commercial products). In the recommendation mode, the user does not issue any query—instead the user interface invokes the recommendation engine 103 automatically on the user's behalf, which returns a list of recommendations (e.g., trip outlines, trip itineraries or destinations) ranked by the relevance assigned by the recommendation engine 103. The user interface then refreshes the area automatically and optionally alerts the user of the arrival of new information (e.g., via a user interface icon).

The details area 802 shows the detailed content of a single destination or trip. The content is determined by the selection made by the user in the search/recommend area 801 or in the work area 803. For example, the user may click on a search result of a recommendation, and the user interface will expand the content of the clicked item and show it in the details area 802.

The work area 803 shows the “work in progress” for the current user. It normally shows an existing trip that the user has created. If no prior trip exists, the user may also create a brand new trip (e.g., using the “Create New Trip” button as shown in FIG. 8). The user may add a search result or a recommendation to the working trip. The user may also click on an item in the trip (e.g., a destination) to expand its content in the details area.

A person skilled in the art of graphics design will appreciate various modifications of the embodiment described above which fall within the teachings of the invention.

What is claimed is:

1. A method for extracting and searching trip itineraries, comprising the steps of:
a. extracting the detailed schedule and the destinations of visit from a plurality of plain text itinerary documents.
b. storing the extracted information in an itinerary database.
c. searching for matching trips in the itinerary database using a plurality of criteria on the trip content.

2. The method recited in claim 1, wherein the plain text itinerary document is stored in a file, a web page or a database record.

3. The method recited in claim 1, wherein a plain text itinerary extractor uses a set of distinctive text patterns in the documents to demarcate the trip schedule.

4. The method recited in claim 1, wherein the document phrases are matched against a point of interest database to identify the destination of visits.

5. The method recited in claim 4, wherein ambiguous matches for the same phrase are resolved by choosing the matches that lead to be most feasible trip itinerary.

6. The method recited in claim 5, wherein the most feasible trip itinerary is the one with the least distance traveled.

7. The method recited in claim 1, wherein the user queries the itinerary database using a language comprising a plurality of destination references, length of stay, trip cost, logical conjunction, logical disjunction and negation.

8. A method for using existing itineraries to make recommendations for trip planning, comprising the steps of:
a. collecting the user information and save it to a user database.
b. retrieving the user information from a user database.
c. matching the user information against the items in an itinerary database and compute a score for each item.
d. returning the top-ranked items to the user as recommendations.

9. A method recited in claim 8, where a trip planning user interface automatically records the user's viewing and booking history and use it to determine the relevance of recommendations.

10. The user database recited in claim 8, comprising information automatically collected from a trip planning user interface about the user, including the user's own trips, the trips and destinations viewed by the user in the recent past, the trips and destinations viewed by the user at the current time and the user's profile data comprising location and demographic attributes.

11. The method recited in claim 8, wherein the user information and the items in the itinerary databases are converted into feature vectors, and a numeric score is computed from pairs of feature vectors to determine relevance.

12. The method recited in claim 11, wherein the feature vector for a destination comprises the unique identifier of the destination, the unique identifiers for the trips visiting the destination and the absolute or relative dates of these visits, the months of visits to the destination, the unique identifiers of the set of destinations that are visited with the given destination on the same date in the same trip, and the profile data of the users that visited the destination in at least one trip.

13. The method recited in claim 11, wherein the feature vector for a trip comprises a merged feature vector from all the destinations visited in the trip, the trip's length and the trip cost when the cost is available.

14. The method recited in claim 11, wherein the relevance score for a pair of feature vectors, each representing a destination or a trip, is computed as the vectors' weighted cosine distance, which is the weighted normalized dot-product of the two feature vectors.

15. The method recited in claim 8, wherein an user receives the following types of recommendations:
a. trip outlines.
b. itineraries.
c. destinations.

16. The method recited in claim 15, wherein a recommended trip outline not only covers the schedule of a specific trip given by the user but also provides additional destinations to visit; in other words, the recommend trip outline fills in the blanks of the given trip.

17. A trip planning user interface comprising the following components:
a. A search area, where the user initiates queries for matching destinations or itineraries and retrieves a plurality of results.
b. A recommendation area, where the user receives a plurality of recommendations relevant to an immediate or a future trip.
c. A details area, where the user zooms in on the details of a single search result.
d. A work area, where the user plans an immediate or future trip.

18. The user interface recited in claim 17, where the interface is shown by a program running in a web browser.

19. The user interface recited in claim 17, where the user may add a destination, trip outline or a whole trip shown in the search area, the recommendation area or the details area to a trip in the work area.

20. The user interface recited in claim 17, where the recommendations are made based on their relevance to the data shown in the search area, the details area and the work area.
